(19) United States
(12) Patent Application Publication
(10) Pub. No.: US 2013/0080180 A1
(43) Pub. Date: Mar. 28, 2013

(54) METHOD AND APPARATUS FOR SENDER PAID DATA DELIVERY

(71) Applicants: MARK FOLADARE, East Brunswick, NJ (US); Richard Bennett, Holmdel, NJ (US); C. Scott Blandford, Yorktown, VA (US); Paul Digiacomo, Whitehouse Station, NJ (US)

(72) Inventors: MARK FOLADARE, East Brunswick, NJ (US); Richard Bennett, Holmdel, NJ (US); C. Scott Blandford, Yorktown, VA (US); Paul Digiacomo, Whitehouse Station, NJ (US)

(21) Appl. No.: 13/240,810

(22) Filed: Sep. 22, 2011

(51) Int. Cl. G06Q 30/00

(52) U.S. Cl. 705/1.1

(57) ABSTRACT

A method and apparatus for providing an option for sender paid data delivery to an endpoint device in a communications network are disclosed. For example, the method sends a request for a content by a subscriber using the endpoint device, receives a plurality of delivery options, wherein one of the plurality of delivery options comprises an option to have a content provider pay for a delivery of the content, selects one delivery option from the plurality of delivery options, and receives the content based upon the one delivery option selected from the plurality of delivery options.

The present disclosure relates generally to payment of data delivery and, more particularly, to a method and apparatus for sender paid data delivery.

### BACKGROUND

In the past, competition led to service providers offering unlimited data plans for their subscribers. As a consequence, data consumption by subscribers has risen exponentially. Accordingly, costs associated with the data delivery has also risen, thereby, making service providers less willing to offer unlimited data plans for the subscribers.

Currently, the trend by service providers is to scale back unlimited data plans and convert their subscribers to a tiered or a capped plan, where the subscribers get a limited amount of data usage for a fixed fee. However, under these subscription plans, the subscriber is charged against their allotment of data usage for any access to the service provider network. There is no way to change who pays for the delivery of the data content.

### SUMMARY

In one embodiment, the present disclosure provides a method for providing an option for sender paid data delivery to an endpoint device in a communications network. In one embodiment, the method sends a request for a content by a subscriber using the endpoint device, receives a plurality of delivery options, wherein one of the plurality of delivery options comprises an option to have a content provider pay for a delivery of the content, selects one delivery option from the plurality of delivery options, and receives the content based upon the one delivery option selected from the plurality of delivery options.

In another embodiment, the present disclosure provides another embodiment of a method for providing an option for sender paid data delivery to an endpoint device in a communications network. In one embodiment, the method receives a request for a content from a subscriber, provides a plurality of delivery options, wherein one of the plurality of delivery options comprises an option to have a content provider pay for a delivery of the content, receives a selection of one delivery option from the plurality of delivery options, and provides the content based upon the one delivery option selected from the plurality of delivery options.

### BRIEF DESCRIPTION OF THE DRAWINGS

The teaching of the present disclosure can be readily understood by considering the following detailed description in conjunction with the accompanying drawings, in which:

FIG. 1 illustrates one example of a communications network of the present disclosure;

FIG. 2 illustrates an example flowchart of a first embodiment of a method for providing an option for sender paid data delivery to an endpoint device in a communications network;

FIG. 3 illustrates an example flowchart of a second embodiment of a method for providing an option for sender paid data delivery to an endpoint device in a communications network; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer readable medium for providing an option for sender paid data delivery to an endpoint device in a communications network. Currently, the trend by service providers is to scale back unlimited data plans and convert their subscribers to tiered or capped plan, where the subscribers get a limited amount of data usage for a fixed fee. For example, rather than providing unlimited data plans, the subscriber may be limited to 2 gigabytes (GB) a month for $19.99 per month.

However, under these subscription plans, the subscriber is charged against their allotment of data usage for any access to the service provider network. There is no way to change who pays for the delivery of the data content.

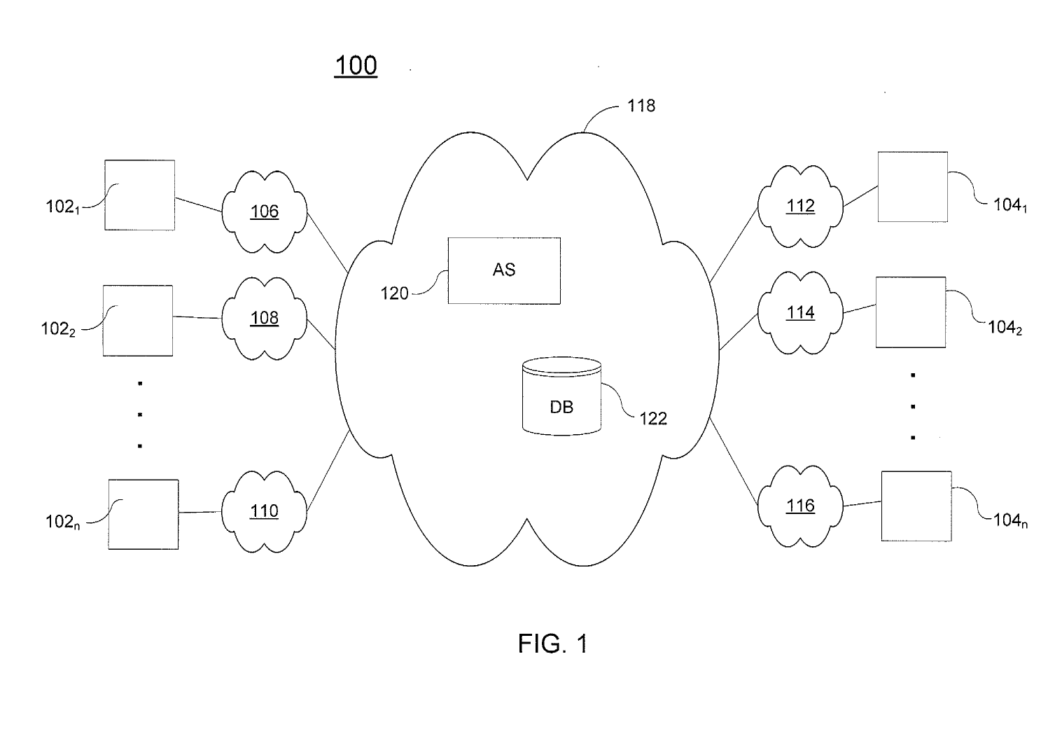

FIG. 1 is a block diagram depicting one example of a communications network 100. The communications network 100 may be any type of an internet protocol (IP) network such as an Internet Protocol (IP) Multimedia Subsystem (IMS) network, an asynchronous transfer mode (ATM) network, a long term evolution (LTE) network, a wireless network, and the like, related to the current disclosure. It should be noted that an IP network is broadly defined as a network that uses Internet Protocol to exchange data packets. Additional exemplary Internet protocol (IP) networks include Voice over Internet Protocol (VoIP) networks, Service over Internet Protocol (SoIP) networks, and the like.

In one embodiment, the network 100 may comprise a core network 118. The core network 118 may be in communication with one or more access networks 106, 108, 110, 112, 114 and 116. The access networks 106, 108, 110, 112, 114 and 116 may include a wireless access network, a Wi-FI network, a cellular access network, a publicly switched telephone network (PSTN) access network, a cable access network, a wired access network, and the like.

In one embodiment, the access networks 106, 108, 110, 112, 114 and 116 may all be different types of access networks, may all be the same type of access network or some access networks may be the same type of access networks and other may be different types of access networks. The core network 118 and the access networks 106, 108, 110, 112, 114 and 116 may be operated by different service providers, the same service provider or a combination thereof.

In one embodiment, the access networks 106, 108 and 110 may be in communication with one or more endpoints 102₁ to 102ₙ (also herein referred to collectively as endpoints 102). The endpoints 102 may be any type of endpoint devices including, for example, a smart phone, a cellular telephone, a laptop, a cable set top box, a tablet device, a desktop computer, a digital video recorder, and the like. In one embodiment, the access networks 112, 114 and 116 may be in communication with one or more content providers 104₁ to 104ₙ (also herein referred to collectively as content providers 104). The content providers 104 may be internet media companies or broadcasting companies such as, for example, Netflix® or ABC®, or individuals that provide media over the internet. Broadly, the content providers 104 may employ various hardware systems, e.g., application servers, video on demand servers, or storage devices for storing various media contents.

In one embodiment, the network 100 may include an application server 120 and a database 122. FIG. 1 illustrates the application server 120 and the database 122 as being within the core network 118. However, it should be noted that the application server 120 and the database 122 may also be located in any one of the access networks 106, 108, 110, 112, 114 and 116. In one embodiment, the application server 120 and the database 122 operate together to perform identity management (IdM).

In one embodiment, the database 122 may store information related to one or more subscribers associated with each one of the endpoints 102 and information related to each one of the content providers 104. For example, subscriber information may include a subscriber's name, a subscriber's address, endpoints associated with the subscriber, subscription information related to a type of subscription, an amount of data the subscriber is allotted under the subscription and the like. The content provider information may include information such as, a content provider's name, the content provider's address, a contractual agreement between a service provider and the content provider and the like.

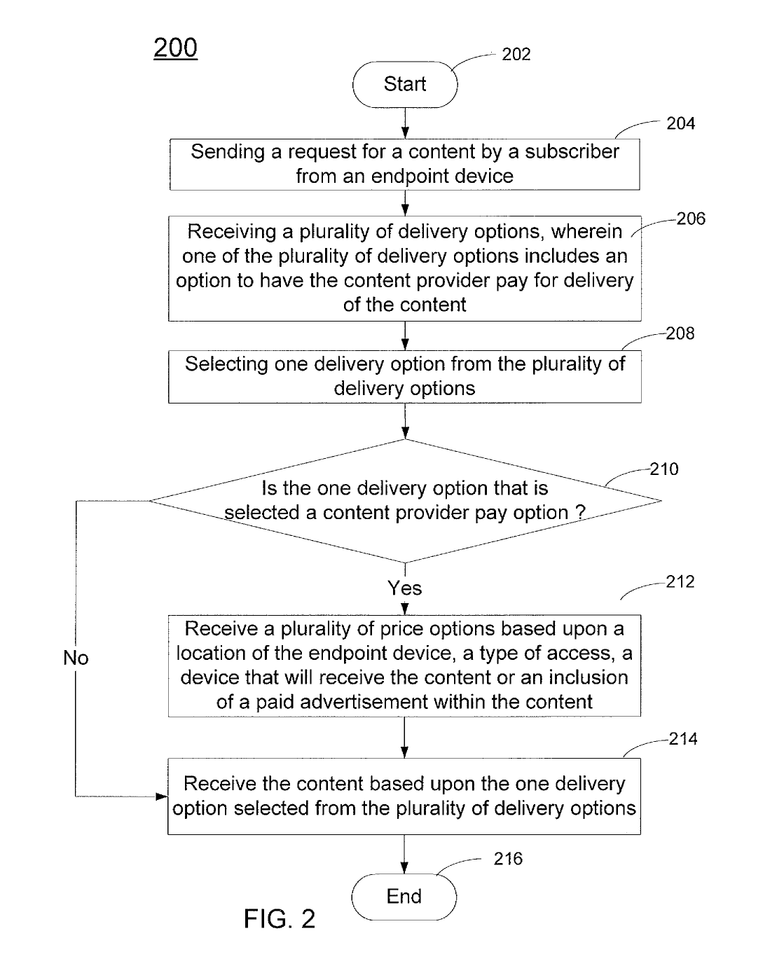

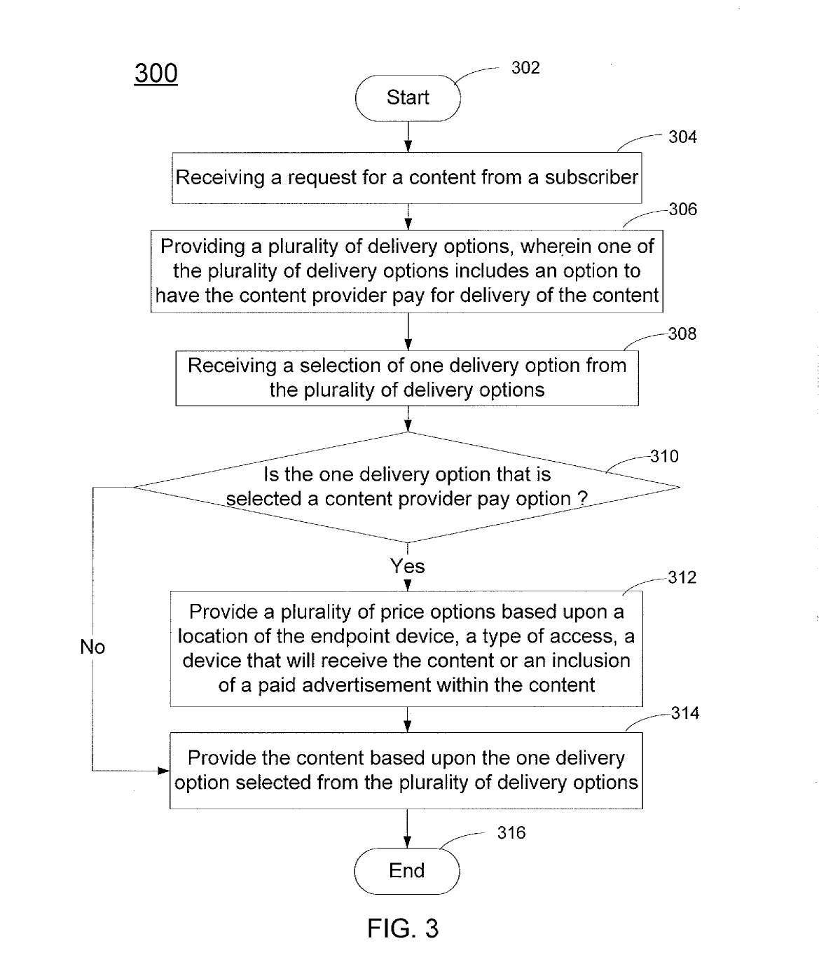

In one embodiment, the contractual agreement may be related to scenarios in which the content provider will pay for the delivery of content requested by a subscriber. The various content provider pay options and scenarios are discussed in further detail below with respect to FIGS. 2 and 3.

It should be noted that the network 100 has been simplified. For example, the network 100 may include other network elements such as border elements, routers, switches, call control elements, policy servers, security devices, a content distribution network (CDN), and the like.

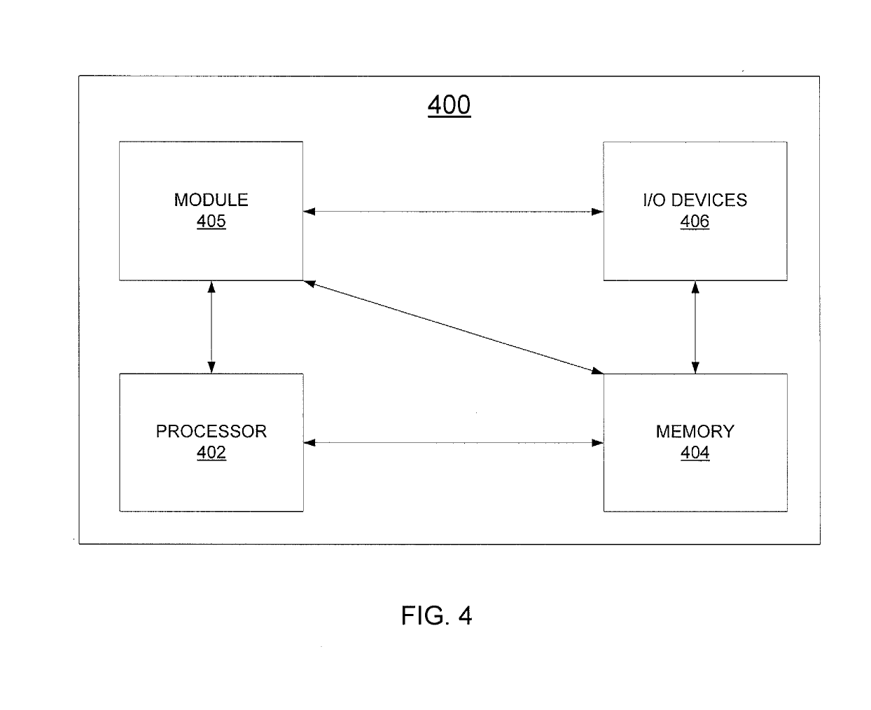

FIG. 2 illustrates a flowchart of a method 200 for providing an option for sender paid data delivery to an endpoint device in a communications network. In one embodiment, the method 200 may be performed by an endpoint device 102 or a general purpose computer as illustrated in FIG. 4 and discussed below.

The method 200 begins at step 202. At step 204, the method 200 sends a request for a content by a subscriber using an endpoint device. In one embodiment, an endpoint 102₄ may be in communication with the access network 106 and the core network 118. In one embodiment, the access network 106 and the core network 118 may be operated by the same service provider. The subscriber of the endpoint 102₁ may be a subscriber of the service provider that operates the access network 106 and the core network 118. Accordingly, the subscriber may request to download content from a content provider 104₁ from his or her endpoint 102₁.

At step 206, the method 200 receives a plurality of delivery options, wherein one of the plurality of delivery options includes an option to have the content provider pay for delivery of the content. As discussed above, typically when a subscriber requests content over a network, the subscriber is charged for delivery of that content. For example, a subscriber will have deducted from his or her allotment of data usage under the subscription plan the amount of data needed to deliver the content.

However, in one embodiment of the present disclosure, various scenarios may be provided that allow the content provider or the sender to pay for at least a portion, i.e., subsidize the cost of delivery, or for all of the costs of the data delivery of the requested content. The pricing of the options presented to the subscriber may be based on a number of factors such as, for example, a time when the subscriber would like to download the content, what type of access that will be used to deliver the content, a location of the endpoint, which particular device will receive the content, whether the content will include paid advertisements, and the like. It should be noted that other factors may be used and the above factors are provided only as examples. How the factors may affect the pricing options are discussed in further detail below.

At step 208, the method 200 selects one delivery option from the plurality of delivery options. At step 210, the method 200 determines if the one delivery option that is selected is a content provider pay option. In one embodiment, one of the plurality of price options may comprise having the subscriber pay for all of the costs of the content delivery. In other words, the full amount of data used will be deducted from the subscriber's allotment of data usage under the subscriber's subscription plan. This may be a scenario where the subscriber wants to download the content immediately, at the subscriber's current location, using any access means necessary, on the subscriber's current endpoint device 102₁. If the selected option is not a content provider pay option (i.e., the subscriber selects to pay for all of the costs associated with delivering the requested content), the method 200 proceeds to step 214.

However, if the selected option is a content provider pay option, the method 200 proceeds to step 212. At step 212, the method 200 receives a plurality of price options based upon a location of the endpoint device, a type of access, a device that will receive the content, or an inclusion of a paid advertisement within the content.

In one embodiment, the content provider pay price options may comprise varying degrees of lower cost options based upon the above listed factors for having the content provider pay for some or all of the costs associated with delivering the requested content. For example, one price option may provide a cheaper option by having the subscriber wait to download the requested content at a later time during off-peak hours. Another cheaper price option may comprise having the subscriber wait to download the requested content when the subscriber is near a Wi-Fi® connection so that the cellular network does not need to be used. Yet another cheaper price option may comprise having the subscriber download the content to a device at home that is known to be on a Wi-Fi® connection during an off-peak time period. As one can see, the cost of delivering the content to the subscriber can be reduced by placing more restrictions on the subscriber as to how and when the requested content will be delivered. It should be noted that other combinations of factors may be used for any varying degree of pricing options.

In one embodiment, one price option may comprise providing the requested content for free if the subscriber selected an option with a paid advertisement. For example, a company could pay the content provider to advertise within the content provider's offered content. Thus, if the subscriber selects the option to watch (or listen to) a paid advertisement, the cost of delivering the requested content can be completely paid for by the content provider via the paid advertisement. For example, the company may include a paid advertisement within the content such that it is not blocked. In another example, the company may pay for exclusive advertisements within the content to pay for the content delivery.

In another embodiment, the company may offer to pay for the delivery of the requested content if the subscriber comes to the location of a company store. For example, if the subscriber is requesting a Disney® video clip, the subscriber will not be charged for data usage if the subscriber goes to the Disney® store to download the requested content. Rather, the company may pay the content provider who then pays the service provider for delivery of the requested content.

In another embodiment, the company may offer a coupon or a rebate to the subscriber. For example, the company may offer coupons that the subscriber may obtain and then submit to subsidize the cost associated with the delivery of the requested content. In one embodiment, the coupon may be an electronic coupon submitted with the request for the content. In another example, the cost associated with the delivery of the requested content may be paid by the subscriber, but then the subscriber may submit a rebate request to later be refunded by the company for a portion of the cost associated with the delivery of the requested content.

In one embodiment, the price options associated with having the content provider pay for at least a portion or for all of the costs associated with delivering the requested content may also include a plurality of options to allow the subscriber to define the associated factors. For example, the subscriber may select a price option to subsidize the cost of delivering the requested content by agreeing to use a Wi-Fi® connection during an off-peak time period. Thus, the subscriber would be presented with a user interface on their endpoint 102₁ to allow them to select a nearby location known to have a Wi-Fi® connection and to select a time during the off-peak time period.

In another embodiment, one of the plurality of price options may simply be a cheaper price at an “optimal” time within a window of time. In other words, instead of allowing the subscriber to choose when and where to deliver the content for a cheaper price, the subscriber may simply be provided an option that guarantees delivery within a predefined period of time, e.g., within the next 24 hours.

As a result, the service provider may monitor network conditions to determine an “optimal” time to deliver the requested content. For example, the network may dynamically detect that the endpoint is connected to a Wi-Fi® connection during a period where there is a below average usage of bandwidth in the network. The service provider may determine that this is an “optimal” time to deliver the content. In another example, the service provider may determine that an “optimal” time is during off-peak hours. Thus, the definition of “optimal” may depend on the availability of network resources and/or other network parameters (e.g., a bandwidth parameter, a packet latency parameter, a drop packet parameter, and so on) that are dynamically determined.

At step 214, the method 200 receives the content based upon the one delivery option selected from the plurality of delivery options. In one embodiment, if the selected option was a content provider pay option, the subscriber may receive a status parameter. For example, the status parameter may include parameters associated with the various factors discussed above, such as, time, location, device status and the like. For example, if the subscriber selected to have the requested content delivered to his home digital video recorder during off-peak hours, the status parameter may indicate that the digital video recorder is on, ready to receive and connected to a Wi-Fi® connection and that the requested content is ready for download at the requested time of 1:00 AM. The method 200 ends at step 216.

FIG. 3 illustrates a flowchart of a second method 300 for providing an option for sender paid data delivery to an endpoint device in a communications network. In one embodiment, the method 300 may be performed by the application server 120 or a general purpose computer as illustrated in FIG. 4 and discussed below.

The method 300 begins at step 302. At step 304, the method 300 receives a request for a content from a subscriber. In one embodiment, an endpoint 102₁ of the subscriber may be in communication with the access network 106 and the core network 118. In one embodiment, the access network 106 and the core network 118 may be operated by the same service provider. The subscriber of the endpoint 102₁ may be a subscriber of the service provider that operates the access network 106 and the core network 118. Accordingly, a request from a subscriber to download content from a content provider 104₁ from the endpoint 102₁ may be received by the core network 118, e.g., by the application server 120.

At step 306, the method 300 provides a plurality of delivery options, wherein one of the plurality of delivery options includes an option to have the content provider pay for delivery of the content. As discussed above, typically when a subscriber requests content over a network, the subscriber is charged for delivery of that content. For example, a subscriber will have deducted from his or her allotment of data under the subscription plan the amount of data needed to deliver the content.

However, in one embodiment of the present disclosure, various scenarios may be provided that allow the content provider or the sender to pay for at least a portion, i.e., subsidize the cost of delivery, or for all of the costs of the data delivery of the requested content. The pricing of the options presented to the subscriber may be based on a number of factors such as, for example, a time when the subscriber would like to download the content, what type of access that will be used to deliver the content, a location of the endpoint, which particular device will receive the content, whether the content will include paid advertisements, and the like. It should be noted that other factors may be used and the above factors are only provided as examples. How the factors may affect the pricing options are discussed in further detail below.

At step 308, the method 300 receives a selection of one delivery option from the plurality of delivery options. At step 310, the method 300 determines if the one delivery option that is selected is a content provider pay option. In one embodiment, one of the plurality of price options may comprise having the subscriber pay for all of the costs of the content delivery. In other words, the full amount of data used will be deducted from the subscriber's allotment of data usage under the subscriber's subscription plan. This may be a scenario where the subscriber wants to download the content immediately, at the subscriber's current location, using any access means necessary, on the subscriber's current endpoint device 102₁. If the selected option is not a content provider pay option (i.e., the subscriber selects to pay for all of the costs associated with delivering the requested content), the method 300 proceeds to step 314.

However, if the selected option is a content provider pay option, the method 300 proceeds to step 312. At step 312, the method 300 provides a plurality of price options based upon a location of the endpoint device, a type of access, a device that will receive the content or an inclusion of a paid advertisement within the content.

In one embodiment, the content provider pay price options may comprise varying degrees of lower cost options based upon the above listed factors for having the content provider pay for some or all of the costs associated with delivering the requested content. For example, one price option may provide a cheaper option by having the subscriber wait to download the requested content at a later time during off-peak hours. Another cheaper price option may comprise having the subscriber wait to download the requested content when the subscriber is near a Wi-Fi® connection so that the cellular network does not need to be used. Yet another cheaper price option may comprise having the subscriber download the content to a device at home that is known to be on a Wi-Fi® connection during an off-peak time period. As one can see, the cost of delivering the content to the subscriber can be reduced by placing more restrictions on the subscriber as to how and when the requested content will be delivered. It should be noted that other combinations of factors may be used for any varying degree of pricing options.

In one embodiment, one price option may provide the requested content for free if the subscriber selected an option with a paid advertisement. For example, a company could pay the content provider to advertise within the content provider's offered content. Thus, if the subscriber selects the option to watch (or listen to) a paid advertisement, the cost of delivering the requested content can be completely paid for by the content provider via the paid advertisement. For example, the company may include a paid advertisement within the content such that it is not blocked. In another example, the company may pay for exclusive advertisements within a content to pay for the content delivery.

In another embodiment, the company may offer to pay for the delivery of the requested content if the subscriber comes to the location of a company store. For example, if the subscriber is requesting a Disney® video clip, the subscriber will not be charged for data usage if the subscriber goes to the Disney® store to download the requested content. Rather, the company may pay the content provider who then pays the service provider for delivery of the requested content.

In another embodiment, the company may offer a coupon or a rebate to the subscriber. For example, the company may offer coupons that the subscriber may obtain and then submit to subsidize the cost associated with the delivery of the requested content. In one embodiment, the coupon may be an electronic coupon submitted with the request for the content. In another example, the cost associated with the delivery of the requested content may be paid by the subscriber, but then the subscriber may submit a rebate request to later be refunded by the company for a portion of the cost associated with the delivery of the requested content.

In one embodiment, the price options associated with having the content provider pay for a portion or for all of the costs associated with delivering the requested content may also include a plurality of options to allow the subscriber to define the associated factors. For example, the subscriber may select a price option to subsidize the cost of delivering the requested content by agreeing to use a Wi-Fi® connection during an off-peak time period. Thus, the subscriber would be presented with a user interface on their endpoint 102₁ to allow them to select a nearby location known to have a Wi-Fi® connection and to select a time during the off-peak time period.

In another embodiment, one of the plurality of price options may simply be a cheaper price at an “optimal” time within a window of time. In other words, instead of allowing the subscriber to choose when and where to deliver the content for a cheaper price, the subscriber may simply be provided an option that guarantees delivery within a predefined period of time, e.g., within the next 24 hours.

As a result, the service provider may monitor network conditions to determine an “optimal” time to deliver the requested content. For example, the network may dynamically detect that the endpoint is connected to a Wi-Fi® connection during a period where there is a below average usage of bandwidth in the network. The service provider may dynamically determine that this is an “optimal” time to deliver the content. In another example, the service provider may determine that an “optimal” time is during off-peak hours. Thus, the definition of “optimal” may depend on the availability of network resources and/or other network parameters that are determined dynamically.

To ensure that the subscriber is not charged for a portion or for all of the costs associated with the delivery of the requested content, the application server 120 may work with the database 122. For example, if the subscriber selected an option to receive a requested content free by including a paid advertisement, the application server 120 may identify the subscriber and the content provider 104₁. Using the identity of the subscriber and the content provider 104₁, the application server 120 may communicate with the database 122 to look up the content provider's contractual agreement with the service provider of the access network 106 and/or the core network 118.

In one embodiment, the contractual agreement may indicate that the content provider 104₁ is to be charged if the subscriber selects an option that includes a paid advertisement. As a result, an amount of data usage allotted to a data plan associated with the endpoint device 102₁ is left unchanged before and after delivery of the requested content. In other words, the subscriber has a data plan with a limited amount of data usage and an amount of data usage allotted to the data plan associated with the endpoint 102₁ before the content is delivered is equal to an amount of data usage allotted to the data plan associated with the endpoint 102₁ after the content is delivered.

In another embodiment, if the subscriber selected an option where the content provider would pay for a portion (e.g., half) of the costs associated with delivery of the requested content, the application server 120 may communicate with the database 122 to look up both the content provider's contractual agreement and the subscriber's subscription plan. Then the appropriate costs may be charged to the content provider 104₁ and the appropriate amount of data usage may be deducted from the subscriber's subscription plan.

It should be noted that other methods may be employed to account for the charges. For example, the subscriber may be charged for the entire amount and then credited for the amount covered by the content provider.

At step 314, the method 300 provides the content based upon the one delivery option selected from the plurality of delivery options. In one embodiment, if the selected option was a content provider pay option, a status parameter may be sent to the endpoint 102₁ of the subscriber. For example, the status parameter may include parameters associated with the various factors discussed above, such as, time, location, device status and the like. For example, if the subscriber selected to have the requested content delivered to his home digital video recorder during off-peak hours, the status parameter may indicate that the digital video recorder is on, ready to receive and connected to a Wi-Fi® connection and that the requested content is ready for download at the requested time of 1:00 AM. The method 300 ends at step 316.

It should be noted that although not explicitly specified, one or more steps of the methods 200 and 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIGS. 2 and 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 providing an option for sender paid data delivery to an endpoint device in a communications network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents. In one embodiment, the present module or process 405 providing an option for sender paid data delivery to an endpoint device in a communications network can be loaded into memory 404 and executed by processor 402 to implement the functions as discussed above. As such, the present method 405 for providing an option for sender paid data delivery to an endpoint device in a communications network (including associated data structures) of the present disclosure can be stored on a non-transitory (tangible or physical) computer readable storage medium, e.g., RAM memory, magnetic or optical drive or diskette and the like. For example, the processor 402 can be programmed or configured with instructions (e.g., computer readable instructions) to perform the steps of methods 200 and 300.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing an option for sender paid data delivery to an endpoint device in a communications network, comprising:
sending a request for a content by a subscriber using the endpoint device;
receiving a plurality of delivery options, wherein one of the plurality of delivery options comprises an option to have a content provider pay for a delivery of the content;
selecting one delivery option from the plurality of delivery options; and
receiving the content based upon the one delivery option selected from the plurality of delivery options.

2. The method of claim 1, wherein the option to have the content provider pay for the delivery of the content comprises a plurality of price options based upon a location of the endpoint device.

3. The method of claim 1, wherein the option to have the content provider pay for the delivery of the content comprises a plurality of price options based upon a type of access that is used to deliver the content.

4. The method of claim 1, wherein the option to have the content provider pay for the delivery of the content comprises a plurality of price options based upon a time the content is delivered.

5. The method of claim 1, wherein the option to have the content provider pay for the delivery of the content comprises a plurality of price options based upon a device type that will receive the content.

6. The method of claim 1, wherein the option to have the content provider pay for the delivery of the content comprises a plurality of price options based upon an inclusion of a paid advertisement within the content.

7. The method of claim 1, wherein the delivery option that is selected comprises the option to have the content provider pay for delivery of the content.

8. The method of claim 7, further comprising:
receiving a status parameter associated with the option to have the content provider pay for the delivery of the content.

9. The method of claim 7, wherein an amount of data usage allotted to a data plan associated with the subscriber before the content is delivered is equal to an amount of data usage allotted to the data plan associated with the subscriber after the content is delivered.

10. A method for providing an option for sender paid data delivery to an endpoint device in a communications network, comprising:
receiving a request for a content from a subscriber;
providing a plurality of delivery options, wherein one of the plurality of delivery options comprises an option to have a content provider pay for a delivery of the content;
receiving a selection of one delivery option from the plurality of delivery options; and
providing the content based upon the one delivery option selected from the plurality of delivery options.

11. The method of claim 10, wherein the option to have the content provider pay for the delivery of the content comprises a plurality of price options based upon a location of the endpoint device.

12. The method of claim 10, wherein the option to have the content provider pay for the delivery of the content comprises a plurality of price options based upon a type of access that is used to deliver the content.

13. The method of claim 10, wherein the option to have the content provider pay for the delivery of the content comprises a plurality of price options based upon a time the content is delivered.

14. The method of claim 10, wherein the option to have the content provider pay for the delivery of the content comprises a plurality of price options based upon a device type that will receive the content.

15. The method of claim 10, wherein the option to have the content provider pay for the delivery of the content comprises a plurality of price options based upon an inclusion of a paid advertisement within the content.

16. The method of claim 10, wherein the delivery option that is selected comprises the option to have the content provider pay for delivery of the content.

17. The method of claim 16, further comprising:
sending a status parameter associated with the option to have the content provider pay for the delivery of the content.

18. The method of claim 16, wherein an amount of data usage allotted to a data plan associated with the subscriber before the content is delivered is equal to an amount of data usage allotted to the data plan associated with the subscriber after the content is delivered.

19. The method of claim 10, further comprising:
monitoring a network parameter to determine if delivering the content is cost optimal.

20. A non-transitory computer-readable medium having stored thereon a plurality of instructions, the plurality of instructions including instructions which, when executed by a processor, cause the processor to perform a method for providing an option for sender paid data delivery to an endpoint device in a communications network, comprising:
receiving a request for a content from a subscriber;
providing a plurality of delivery options, wherein one of the plurality of delivery options comprises an option to have a content provider pay for a delivery of the content;
receiving a selection of one delivery option from the plurality of delivery options; and
providing the content based upon the one delivery option selected from the plurality of delivery options.
